(19) United States
(12) Patent Application Publication
(10) Pub. No.: US 2008/0072492 A1
(43) Pub. Date: Mar. 27, 2008

(54) Plant watering/food dispersing system

(76) Inventor: Melissa Ann Olson, Limerick, PA (US)

Correspondence Address: MELISSA OLSON, 108 REGAL COURT, LIMERICK, PA, 19468, US

(21) Appl. No.: 11/510,070

(22) Filed: Aug. 25, 2006

(51) Int. Cl. A01G 25/00

(52) U.S. Cl. 47/79

(57) ABSTRACT

A plant watering/food dispersing system to enable plants to be watered automatically. The system may be co-located with each pot. The owner of the plant may not have to remember periodic watering of the plant. A timer may control the system. Water/plant food may be pumped from a container to the plant. In one embodiment, the container may hold water or water/plant food. In another, the container may be placed beside a pot, which may be useful for consumers who already own pots. In another embodiment, the timer and container may be placed in a hole within the pot to hide the system. This may be useful for a plant on a foyer table. In another embodiment, multiple hoses may be used to water plants in multiple pots. In another embodiment, the timer may be an electric timer. An alternative embodiment may be a solar timer or a battery operated timer. Overall, the system may be useful to water plants on a regular basis automatically.

### FIELD OF INVENTION

The present invention relates to plant watering devices. More particularly, the present invention relates to plant watering devices that may provide water and/or plant food automatically. The system may be co-located with the pot for each individual plant.

### BACKGROUND OF THE INVENTION

It is necessary to provide water and plant food to a plant's soil to properly care for them. Many water devices have been developed where the owner has to carry the water and/or plant food to the pot each time the plant needs water and/or plant food. The house watering plant is normally watered via a pitcher, which requires the person to be home and remember to water the plant. Many people travel a lot and are very busy so they may not have time to water their plants often.

Many other devices have been developed where the watering system is dispersed from a centralized location. This may work well for a lush environment. However, this may not work as well in a home and may be costly for many homeowners. People may not want to run hoses throughout their house to reach multiple pots. The plant watering/food dispersing system may enable better care of plants. Other watering plant systems exist for large-scale usage; for example, lawn care sprinkler systems and watering systems for a large number of plants. Systems that currently exist disperse water from a central location. In the present invention, each plant may have its own system.

Many other watering systems use a watering hose connected to a water source. However, watering hoses may be heavy and are limited to their lengths.

None of the systems described above are well suited for watering plants, giving them plant food automatically, and being co-located with each pot. Also, these systems don't have a way to measure the amount of water and plant food being dispersed. The timer may regulate how long and how often the water and/or plant food may be dispersed.

It may be desirable to water plants and give plants food automatically. It may also be desirable to provide a system to control how often plants receive water and/or plant food. Furthermore, it may be desirable to de-centralize the plant watering system and co-locate the system with each pot.

### BRIEF SUMMARY OF THE INVENTION

The present invention is directed to a plant watering system that provides water and/or plant food to plants automatically by de-centralizing the system. The watering system is co-located with each plant.

The design of the system for the plant is unique. Each pot may also have a watering system and/or plant food system for that plant. In a preferred embodiment, the pot may have a container beside it. In another preferred embodiment, the pot may contain an opening at the bottom of the pot for the container. This opening may be covered with a door or left open. The container may contain a hole for water and/or a hole for plant food. The container may also contain a pump to regulate water and/or plant food dispersal to the plant.

In operation, the timer may signal the pump at a certain time and for a certain length of time to disperse water and/or plant food to the plant. In a preferred embodiment, the timer may contain an electric cord to plug into an electric outlet. However, in an alternative embodiment, the timer may be solar or battery operated. In another alternative embodiment, a moisture control thermometer may be used to signal the pump when the moisture gets below a certain level in the soil.

The plant watering/food dispersing system may provide the ability to water plants on a regular basis automatically. A timer may be set to water the plants on a scheduled basis (every day, every other day, etc.). For houseplants, the pot may have a space in the bottom where the container may be removed and refilled. Also, containers may be available in multiple options. A container may have an option to have extra space for plant food, which may also be scheduled to be released by the timer.

In an alternative embodiment, any system with 2 or more different plants on the same saucer may each have their own system or have multiple hoses from the same system. For example, this embodiment may be an herb garden.

In another alternative embodiment, a system may be used to water Christmas trees. The owner of the tree may not have to crawl under the tree to water it. A larger water container may be beside the tree. The hose may run from the container to a hole in the top of the pot where the tree stands. Also, both the container and pot may have a lid on them to eliminate the problems of evaporation and animals drinking the water from the tree.

This simplified plant watering/food dispersing system may be used in businesses or in homes. Many large-scale watering systems may be more costly and aren't feasible for some people or businesses. For example, a business may be able to cut down on plant maintenance costs by using this system. This system may provide an advantage to people who travel and aren't home a lot to take care of their plants. Also, people who often want plants, but can't remember to water them, may have lovely plants with this system.

It is an object of the present invention to water plants and give plants food automatically. It is an object of the present invention to control how often plants receive water and/or plant food. It is an object of the present invention to de-centralize the plant watering system and co-locate the system with each pot.

### BRIEF DESCRIPTION OF THE SEVERAL VIEWS OF THE DRAWING

FIG. 1 is a detailed description of the system with the container outside of the pot

FIG. 2 is a description of the system with the container inside of the pot

FIG. 3 is a description of a container for water only

FIG. 4 is a description of a container for water and plant food

FIG. 5 is a description of options for the lid on the container

FIG. 6 is a description of the timer

### DETAILED DESCRIPTION OF THE INVENTION

The plant watering/food dispersing system may provide the ability to water plants on a regular basis automatically. The pot may contain a slot in the bottom where a container for water and/or plant food may be placed. If the pot doesn't have the container as part of it, the container may be placed beside the plant. A timer may allow water to be dispersed to the plant on a regular basis. A hose may run from the water container to the plant to allow the water to be dispersed.

While the present invention is susceptible of embodiments in various forms, as shown in the drawings, hereinafter will be described the presently preferred embodiments of the invention with the understanding that the present disclosure is to be considered as an exemplification of the invention and is not intended to limit the invention to the specific embodiments illustrated.

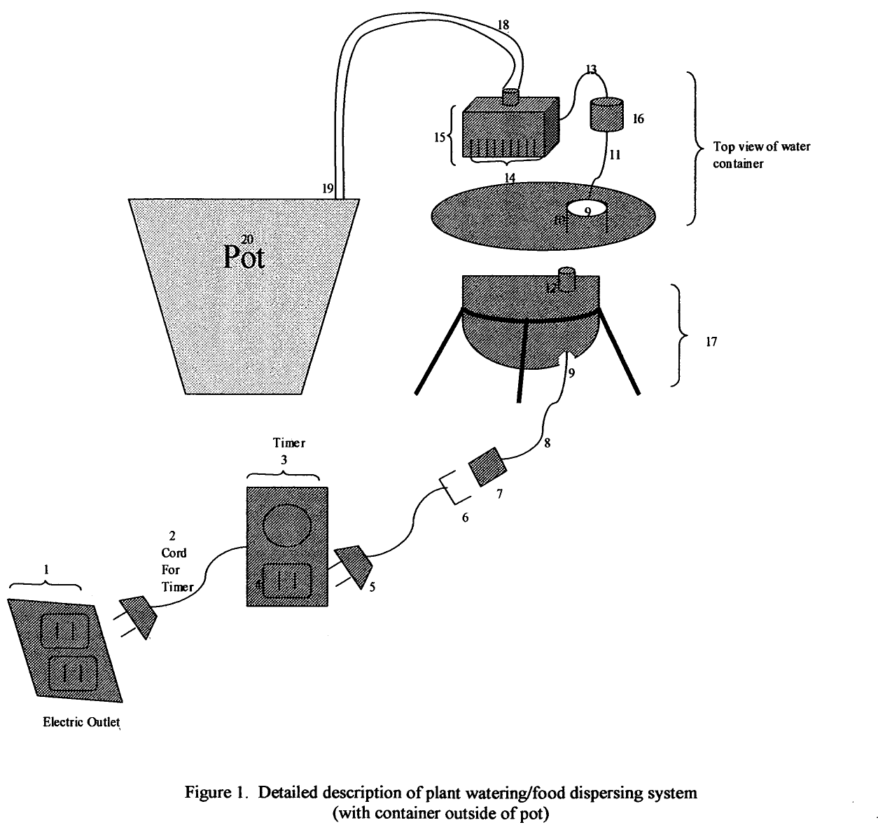

FIG. 1 describes the overall operations for the plant watering/food dispersing system. This example describes a system where the container 17 may be outside the pot 20, instead of embedded within the pot. The cord 2 for the timer may be plugged into an electric outlet 1. The timer 3 may determine when and how long to disperse the water. The timer may also have an electric outlet 4, where the cord 5 for the water pump may be inserted. In order to fit into the hole 9 in the bottom of the container 17, the cord must be split into 2 pieces and connected at 6 & 7. The purpose of this is to allow the pump 15, cords 11& 13, and rubber stopper 16 to fit into the top of the pot. Furthermore, the electric cord 5 may be too large to fit through the bottom of the hole so 6 and 7 may be able to connect the two pieces together. The cord 8 may then fit thought the hole 9 in the container 17. The cord 11 may continue through the hole 9. The rubber stopper 16 may then fit over the mouth 10 on the container to ensure that water may not leak out of the hole. The hole 9 and the mouth 10 may be at the bottom of the container 17. The cord 13 may then continue through the rubber stopper 16 to pump 15. This whole connection may allow power to get from the electric outlet 1, through the timer 3, and into the pump 15. The pump may then need to have holes 14 in the bottom of it to be able to pump the water from the container 17 into the hose 18. The water then gets dispersed through a hose 18 into the pot 19. A lid 12 may be used to fit the hose through, which may eliminate the water from evaporating or being drank by an animal. Now the plant in the pot 20 has received water automatically.

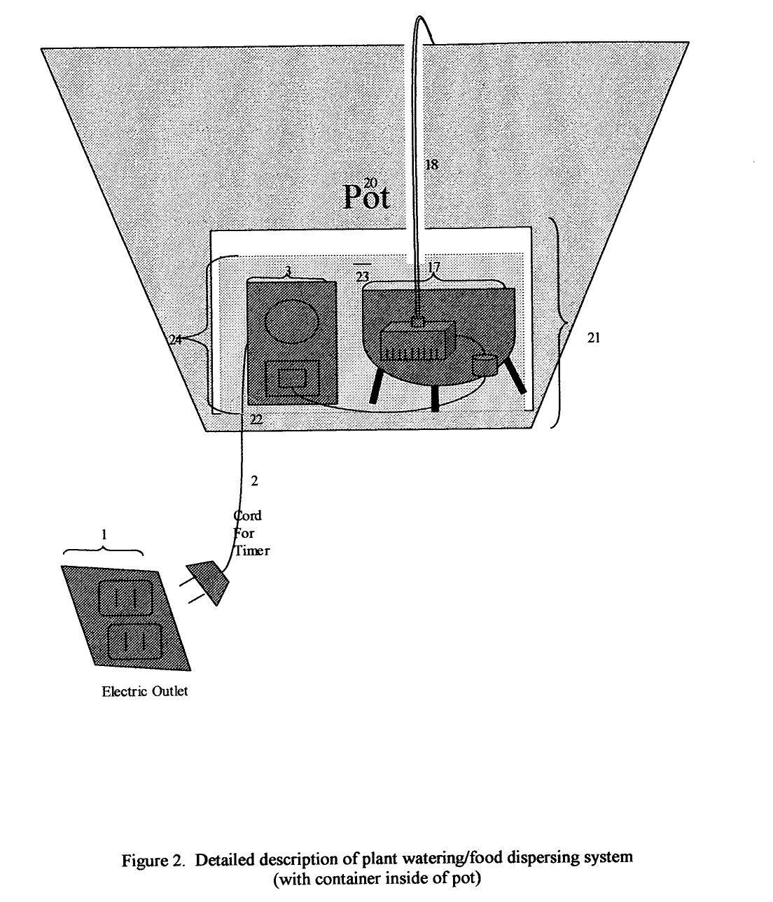

FIG. 2 depicts a pot that may contain a hole 21 in the bottom to be able to insert a timer 3 and container 11 for food and/or water. The top of the pot may still contain the dirt and the plant. However, the benefit of this pot is that the container 17, timer 3, and hose 18 may be embedded within the pot behind a door 24. The timer and water container may be hidden behind a door 24 that may open with snap 23. The snap 23 may be similar, but not limited to those used on the front of televisions or computers to hide the controls that aren't often needed. If an electric timer is used, the cord 2 may be the only item of the system visible. The cord 2 may fit through a hole 22 in the door 24. This type of pot may be desirable for displaying a plant on a table where people may see all sides of the pot. For example, this may be useful for a plant displayed on a circular table in a foyer of a home.

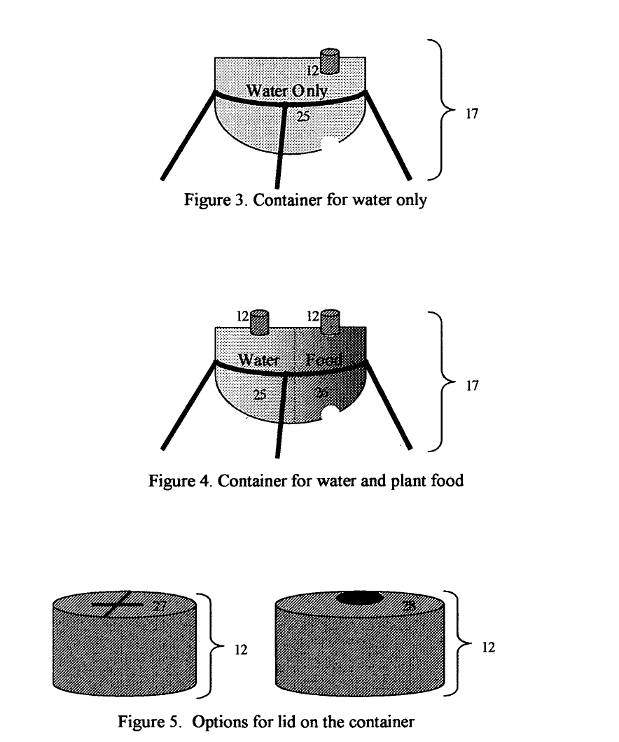

FIG. 3 depicts a container that may only contain water 25. This may be used for a plant that requires no or little plant food. The containers may be made of plastic, but isn't limited to this type of material. The container may contain a hole with a lid 12 on the top.

FIG. 4 depicts a container that may contain both water 25 and plant food 26. This may be used for a plant that requires plant food often. Notice that there may be two or more holes and lids 12 in the top of the water container where the hoses may be inserted. Two or more timers may be needed to disperse the different sides of the container.

FIG. 5 shows two examples of lids 12 for the container. The lid may be a screw on lid, similar to, but not limited to a lid on a soda bottle. The first lid shows a slit in the top of the lid where the hose may fit through 27. This part of the lid may be made of any flexible material. An example of a flexible material is plastic. The slit may be similar to a slit in a lid used for a fountain drink. Another option may be to use a hole in the top of the lid 28. Again, the plastic in this option may need to be flexible for the hose to fit through or the hole may need to be large enough for the hose to fit through.

Digital timers, segment timers with a dial to turn, or other timers may be used to disperse the water. These timers may be similar to the ones used to turn on lights or the ones used in irrigation systems. The timer may then turn on the pump to disperse water info the plant. The following timers may be used for dispersing, but aren't limited to: DIG Battery Operated Timer and 2-Dial Orbit Hose Faucet Timer. However, these examples are used for irrigating with a large watering hose, instead of a hose for a single plant. The timers may require people to program how often water or plant food should get dispensed into the plant.

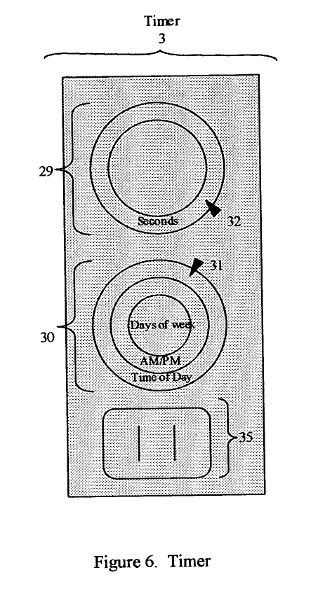

FIG. 6 shows a timer with a dial for determining how long to disperse water and/or plant food and another dial for determining how often. It may have two circular dials (29 and 30) in the center of the timer. The circular dial 29 may be used for determining how long to disperse the water; it may be displayed in seconds, but is not limited to seconds. The circular dial 30 may be used for determining when to disperse the water; it may contain the days of the week, am/pm, and time of day, but is not limited to this timing system. Pegs 31 and 32 may then be marked at different times to disperse the water. The electric cord may be plugged into the electric outlet 4. Two timers may be needed for containers with both water and plant food. An example of a timer with a dial that may be similar to turn off lights and appliances includes, but is not limited to, American Tack & Hardware Weekly Segment Timer.

The benefit of the digital timer may be that they may have a more sophisticated programming. However, people who prefer not to use electronics and prefer simple solutions may use the manual timers. Multiple timer options may be available to users because of the different level of understanding with electronics. An example of a digital timer includes, but is not limited to, American Tack and Hardware Weekly Digital Timer that is used to turn on and off appliances and lights.

The pump that is used may be similar to, but is not limited to, the Homedics submersible fountain pump. This pump may have holes in the bottom to intake the water and a hole in the top where a hose may be inserted to disperse the water to the plant.

Some benefits of the system are for people who have trouble remembering to water their plants or people who often travel. The owner of the system may fill the water dispenser less often than if they had to manually water their plants. Also, they may use the different options depending on their situation. For example, a person may already own a lot of plants so they may just buy the water container and timer to water their plants. If a person wants to place a plant in the center of a table, they may buy a pot that may hide the water/food container, timer and hose. The electric cord and piece of the hose may be the only visible items. Also, battery operated timers/pumps or solar operated timers/pumps may be used to hide the pieces of the system.

I claim:

1. A plant watering system comprising:
a pot;
a container;
a hose;
a timer; and
a pump;
wherein said plant watering system is co-located with said pot.

2. The plant watering system of claim 1, wherein said pot further comprises a plant.

3. The plant watering system of claim 1, wherein said container is located inside said pot.

4. The plant water system of claim 1, wherein said container is located outside said pot.

5. The plant watering system of claim 1, wherein said container holds water.

6. The plant watering system of claim 1, wherein said container holds plant food.

7. The plant watering system of claim 1, wherein said container holds both water and plant food.

8. The plant watering system of claim 1, wherein said hose disperses water and/or plant food to said pot.

9. The plant watering system of claim 1, wherein said timer schedules periodic watering and/or plant food dispersals.

10. The plant watering system of claim 1, wherein said pump pumps water and/or plant food to said pot.

11. The plant watering system of claim 1 comprising two or more said pots.

12. The plant watering system of claim 1 comprising two or more said hoses.

13. The plant watering system of claim 1 comprising two or more said timers.

14. The plant watering system of claim 1 comprising two or more said pumps.

15. The plant watering system of claim 1 comprising two or more said containers.
